(19) United States
(12) Patent Application Publication
(10) Pub. No.: US 2005/0160621 A1
(43) Pub. Date: Jul. 28, 2005

(54) Circulating air dryer for material webs

(76) Inventor: Wilhelm Hartmann, Voegelsen (DE)

Correspondence Address: Striker Striker & Stenby, 103 East Neck Road, Huntington, NY, 11743, US

(21) Appl. No.: 10/515,128

(22) PCT Filed: Jun. 24, 2003
(86) PCT No.: PCT/EP03/06633

(30) Foreign Application Priority Data
Jun. 29, 2002 (DE) 102293686

(51) Int. Cl. F26B 9/00; F26B 13/00

(52) U.S. Cl. 34/629; 34/638

(57) ABSTRACT

A problem associated with known circulating air dryers, e.g. for a textile material web is that the quantity of circulating air depends on both the desired drying behaviour and on the suspended guidance of the material web. A minimum quantity of circulating air must be maintained to prevent the position of the material from becoming unstable in the treatment chamber. The aim of the invention is to provide a circulating air dryer, in which the material web is suspended in a steady manner by a cushion of air, independently of the air flow. To achieve this, the nozzle chambers (7, 8), by means of which air is blown onto the material web (1) and evacuated through return flow channels, are equipped with elements for at least partially closing the return flow channels. This permits the air pressure between the material web (1) and the nozzle chambers (7, 8) and thus the carrying force of the air to be regulated. Said dryer can be used for the finishing of textiles.

The invention relates to a circulating air dryer as generically defined by the preamble to claim 1.

Such dryers are used in textile finishing, for example for fixing or drying webs of material.

From German Patent Disclosure DE 30 23 200 A1, a dryer for a length of material is known in which a quantity of air which is blown onto a length of material is controlled as a function of the actual status of the length of material to be dried. Opening and closing devices are provided at the blowout openings of nozzle chests and uncover or partially or entirely close the blowout openings.

For varying the position of the goods, various devices have become known, in which one fan in each field is assigned to one upper and one lower nozzle chest assembly. For instance, European Patent Disclosure EP 471 162 B1 describes a machine for heat treating a length, or web, of textile material, in which pressure chests extend over the width of the nozzle chests, and in which the two fans are disposed at the same height within the entrance region to the associated pressure chests. This makes the machine complicated and expensive.

European Patent Disclosure EP 162 946 B1 describes a heat treatment device for unstable webs of material, in which treatment agents in gaseous or vapor form are blown onto the web of material from nozzle bodies, which have inflow and outflow openings, disposed two-dimensionally above and/or below the web of material, and the treatment agents are removed again by the same means. The delivery and removal of the treatment agents is effected without significant flow components longitudinally or transversely to the web of material. One treatment unit each comprising inflow and outflow openings is provided, and in each case a plurality of inflow openings are arranged in a star or a ring around a central outflow opening.

German Patent Disclosure DE 199 15 923 A1 describes a circulating air dryer of this generic type, with one or more fields disposed one after the other, in which fields a horizontal conveyor device for a web of material and circulating air devices are disposed. Via nozzle chests, treatment agents are blown onto the web of material and subsequently removed by suction again. A bypass valve is disposed between a pressure chamber and a return flow chamber of the air circuit.

A disadvantage of the known devices is the necessity that a minimum quantity of the treatment agent must be blown onto the web of material, the quantity depending on the moisture and quality of the web of material, such as the weight per unit of surface area, in order to keep the web of material securely floating. With vulnerable goods which require only a slight inflow quantity, the position of the goods can become unsteady in the treatment chamber.

Taking DE 199 15 923 A1 as the point of departure, the present inventor made it his object to create a circulating air dryer in which a largely calm position of the goods is attained, regardless of the air flow.

This object is attained by the characteristics of the body of claim 1. Because means for at least partial closure of the return flow conduits are provided, the outflow of the circulating air from the space between the nozzle chests and the web of material can be varied and an air cushion thus formed. Regardless of the air flow blown onto the web of material, a flow that is adjustable for instance by means of the fan rpm and/or a valve in the nozzle chest, the air pressure between the web of material and the nozzle chest and thus the lift of the air can be adjusted. The quantity of circulating air can thus be adjusted solely as a function of the need for drying, while the position of the goods in the dryer can be varied by the means for closing the return flow conduits.

The dependent claims pertain to how the invention is advantageously embodied.

A plate and a displacement device in accordance with claim 2 are simple and inexpensive to produce and to install. They are also excellently well suited for retrofitting existing circulating air dryers, because only a few parts in all have to be installed additionally. By displacement of a single part—namely the plate—the free flow through all the return flow conduits of the nozzle chest can be adjusted.

The holes in the plate are disposed such that in the “open” position, each hole is aligned with the extension of an associated return flow conduit, so that the full cross section of the return flow conduit is available. This means that the disposition of the holes corresponds to the disposition of the return flow conduits in a plane parallel to the plate. The holes may have the same cross section as the return flow conduits, or they may have some different shape and/or size.

Hole shapes in accordance with claim 3 or 4 have the advantage that in normal operation, the opening between each return flow conduit and hole has no acute angles, and thus the risk of the accumulation of fluff, for instance, causing clogging, is low.

Different cross sections of the holes in accordance with claim 5 have the effect that the air pressure profile can be varied over the surface area.

A displacement device with at least one Bowden cable and an adjusting device in accordance with claim 6 is inexpensive and, given a manual adjusting device, requires no expense for additional control and supply lines. For the automatic adjustment, hydraulic or pneumatic cylinders are especially well suited.

Reinforcements in accordance with claim 8 make it possible to use a thin and hence lightweight plate.

The disposition of the means on only the lower nozzle chests in accordance with claim 9 achieve great success at comparatively little expense.

The invention will be explained further in terms of an example. In the schematic drawing,

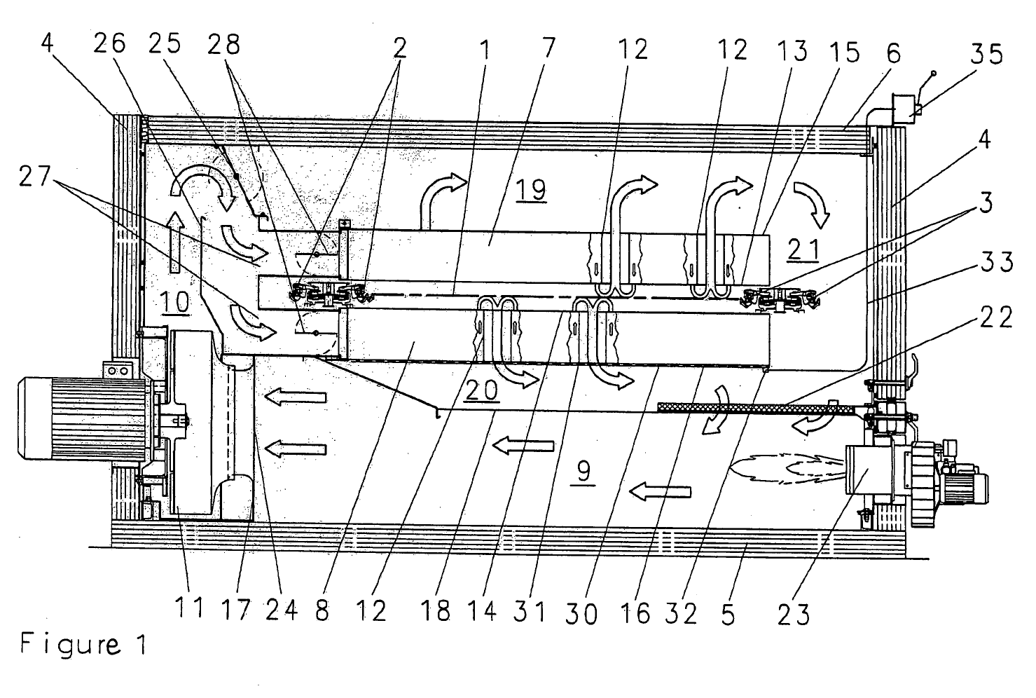

FIG. 1 shows a field of a circulating air dryer in cross section;

FIG. 2 shows a cross section of a lower nozzle chest;

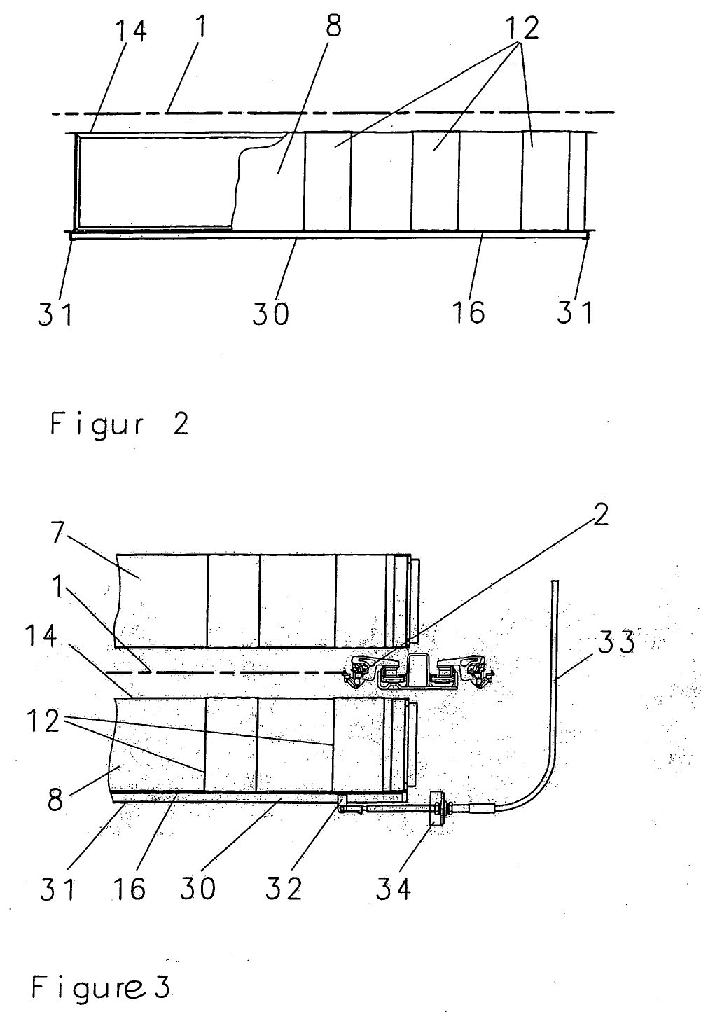

FIG. 3 shows a part of one lower and one upper nozzle chest in section in the form of a detail;

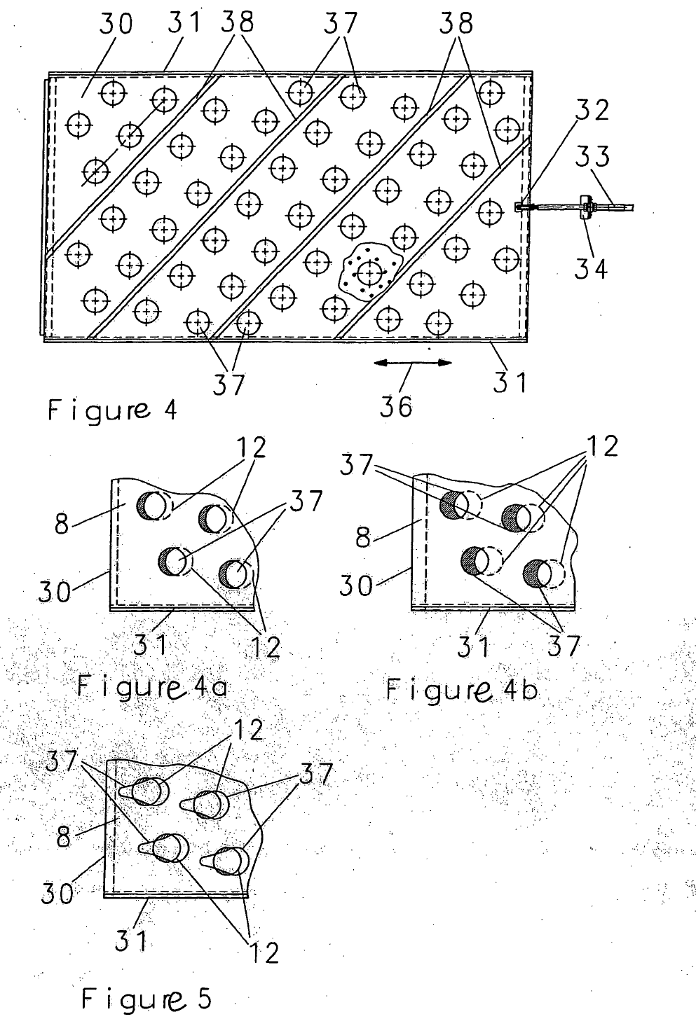

FIG. 4 shows the lower nozzle chest perpendicularly from below along with partial views for different degrees of opening (4a and 4b); and

FIG. 5 shows a different embodiment of a hole.

A circulating air dryer has a plurality of fields, disposed one behind the other in the transporting direction, and a conveyor device for a web of material 1, namely a tentering frame, with two tentering chains 2, 3, which are guided in rails horizontally through the fields of the circulating air dryer.

The circulating air dryer is provided with a block-shaped, insulated housing with lateral housing walls 4, a housing bottom 5, and a housing top 6. The fields are separated from one another by partitions, not shown, with openings for the web of material 1 and the tentering chains 2, 3 and optionally with valves.

In each field, there is one circulating air device, with at least one nozzle chest 7 above and at least one nozzle chest 8 below the web of material 1, with a circulating air fan 11, an intake chamber 9 on the suction side, and an air supply chamber 10 on the compression side of the circulating air fan 11. In this example, there is one upper and one lower nozzle chest 7, 8 in each field. The nozzle chests 7, 8 extend in terms of their length over at least the maximum width of the web of material and over approximately 70% of the width of the circulating air dryer.

The nozzle chests 7, 8 are embodied as block-shaped sheet-metal chests. They have evenly distributed return flow conduits, formed of tubular segments 12, for the outflow of the circulating air. The tubular segments 12 in each nozzle chest 7, 8 connect the respective wall 13, 14, oriented toward the web of material 1, to the opposite wall 15, 16. The wall 13, 14 of the nozzle chests 7, 8 that is oriented toward the web of material 1 is provided with inflow openings, not shown individually and arranged for instance in a circle around the tubular segments 12. Each of the nozzle chests 7, 8 has one inlet opening 27, which extends over nearly the entire height and width of each nozzle chest 7, 8; all the inlet openings 27 are disposed on one side of a field. On this side, the nozzle chests 7, 8 protrude toward the wall 4, somewhat past the tentering chain 2. Downstream of the inlet openings 27, distributor valves 28 are disposed in the nozzle chests 7, 8.

A partition 17 extends from the housing top 6 parallel to the housing wall 4 to the housing bottom 5; it is disposed on the ends of the nozzle chests 7, 8 that have the inlet openings 27. The partition 17 divides the air supply chamber 10 from the interior of the field. A false bottom 18, which begins at the opposite housing wall 4, abuts against this partition 15 and divides the intake chamber 9 from the interior. The height of the intake chamber 9 is approximately one-fourth the total height of the field.

Above, below, and on the side toward the housing wall 4 of the nozzle chests 7 disposed approximately centrally along the width of the dryer, return flow chambers 19, 20, 21 defined by the partition 17, the housing top 6, the housing wall 4, and the false bottom 18 remain free. Below the lateral return flow chamber 21, at least one filter 22 is let into the false bottom 18. By means of the filter 22, the return flow chambers 19, 20, 21 that are open toward one another communicate with the intake chambers 9 that are defined by the false bottom 18 and the housing bottom 5. Below the filter 22, for instance in the middle of the field length, a heater, in this case a gas burner 23, is disposed on the housing wall 4. The circulating air fan 11, embodied as a radial fan, is disposed on the side opposite the gas burner 23, likewise in the center of the field length, at the end of the intake chamber 9 in the air supply chamber 10, so that its compression side is located in the air supply chamber 10. Its suction side communicates with the intake chamber 9 through an opening 24 in the partition 17. To improve the flow to the circulating air fan 11, the false bottom 18 is angled upward before directly abutting the partition 17 directly above the opening 24. Above the upper nozzle chests 7, the partition 17 has one or more bypass valves 25.

A dividing baffle 26 that forms a partition is disposed in the air supply chamber 10 and divides the air supply chamber 10 into a pressure chamber, associated with the fan, and a distribution chamber, associated with the inlet opening 27.

To this extent, the circulating air dryer is equivalent to the prior art.

The description below will be made in conjunction with FIGS. 2 through 4.

Below each lower nozzle chest 8, a perforated plate 30 is disposed displaceably, such that it conforms closely to the lower wall 16 of the nozzle chest 8. The size of the plate 30 is equivalent to the size of the wall 16. The holes 37 in the plate 30 are round, and their diameter is equivalent to the inside diameter of the tubular segments 12. The disposition of the holes 37 in the plate 30 is equivalent to the disposition of the tubular segments 12 in the nozzle chest 8 and thus to the pattern of holes in the wall 16, so that the holes 37 and the return flow conduits—given a defined relative position of the plate 30 with respect to the nozzle chest 8—are in alignment with one another. The plate 30 is guided in two guide rails 31, which are secured below, in the vicinity of and parallel to the long sides of the wall 16, and extend over the length of the wall 16.

The plate 30 is made from sheet metal, for instance, or heat-resistant plastic.

On the underside of the plate 30, that is, on the side remote from the nozzle chest 8, reinforcements 38 are provided, which extend parallel to holes that extend in a line. The reinforcements 38 are made from flat profile sections, for instance, that are secured to the plate 30.

The guide rails 31 are made from L- or U-shaped profiles, for example, and are welded, screwed, or in some other way secured to the wall 16.

On the end of the plate 30 located in the other direction from the inlet opening 27, there is at least one bolt 32, to which one end of a displacement device, in this case a Bowden cable 33, is secured. An associated end of a sheath of the Bowden cable 33 is firmly retained at an abutment 34, which is secured to the housing via a prop. Another end of the Bowden cable 33 is extended out of the housing and ends in a manual adjusting device 35, which engages that end and pulls or presses on it and in this way displaces the plate 30 continuously variably along the guide rails 31 in the direction of the double arrow 36. The adjusting device 35 is secured to the housing, for instance on the outside at the top.

In FIGS. 4, 4a and 4b, various relative positions of the plate 30 are shown. In FIG. 4, the tubular segments 12 are fully open; in FIG. 4a, they are ⅓ closed; and in FIG. 4b, they are ⅔ closed.

In FIG. 5, a different design of the holes 30 with disproportionate regulating behavior can be seen. Each hole 30 is mirror-symmetrical to its longitudinal axis and is in the shape of a pear. From one wide end of the hole 37, which has the form of a circular arc and is approximately equivalent to the diameter of the tubular segment 12, the hole 37 tapers on each side in the form of a hyperbola toward its narrow, circular-arc-shaped end. The proportion of length to width is approximately 1 to 3. Each tubular segment 12, in the position of the plate as shown, is approximately 5/6open.

Instead of the manual adjusting device 35, a motor, pneumatic, or hydraulic drive can also be used, which makes simpler automation possible.

The displacement device can also engage the bolt 32 directly, if for instance it is embodied as a hydraulic or pneumatic cylinder, optionally with extension rods.

In operation, the treatment agent, that is, the drying air, is delivered to the web of material 1 through the nozzle chests 7, 8 via the inflow openings. The drying air absorbs the moisture from the web of material 1, giving up heat, and flows as waste air through the tubular segments 12, through the nozzle chests 7, 8, and laterally of the nozzle chests 7, 8 into the return flow chambers 19, 20, 21. Some of the waste air from one field is carried for instance in countercurrent fashion in the circulating air dryer into the preceding field, and a corresponding proportion of the waste air from the downstream field is carried into the return flow chambers 19, 20 or 21 of that field. The waste air coming out of the return flow chambers 19, 20, 21 is cleaned in the filter 22, is heated with the air of the gas burner 23 to become drying air in the intake chamber 9, is aspirated through the circulating air fan 11, and is forced via the air supply chamber 10 into the nozzle chests 7, 8.

The drying parameters, such as the temperature and quantity of the drying air, are adjusted and optionally regulated as a function of the quality and vulnerability of the web of material 1 and of the quantity of water to be evaporated.

The position of the goods is monitored, for instance by a sensor, and is adjusted by displacement of the plate: If the web of material 1 is sagging downward, the plate 30 is displaced such that the outlet cross section of the tubular segments 12 is reduced, until a position of the goods that is precisely uniform and calm over the width of the web of material 1 is attained. Hence a greater air dam between the web of material and the lower nozzle chest 8, with adequate lift, is formed than without the invention; this is especially favorable when the quantities of drying air are slight. If the web of material 1 bulges upward too much, which has the risk of uneven heat treatment of the web of material, then the plate 30 is displaced such that the outlet cross section of the tubular segments 12 is increased, until precisely a desired position of the goods is attained.

1. A circulating air dryer for a web of textile material, having a conveyor device for the web of material, having a circulating air device, having means for adjusting the quantity of air, having nozzle chests, disposed above and below the web of material, for blowing treatment agents onto the web of material and removing them by suction, inflow openings and return flow conduits being disposed in the nozzle chests, characterized in that means for at least partial closure of the return flow conduits are disposed on at least one nozzle chest (7, 8).

2. The circulating air dryer of claim 1, characterized in that the return flow conduits are formed of tubular segments (12), and the means for closure are formed of a plate (30) and a displacement device, the plate (30) being guided displaceably immediately adjacent the wall (13, 14) of the nozzle chest (7, 8) remote from the web of material (1), and holes (37) corresponding to the return flow conduits being disposed in the plate (30).

3. The circulating air dryer of claim 1, characterized in that the holes (37) are round or oval.

4. The circulating air dryer of claim 1, characterized in that each hole (37) is embodied as pear-shaped.

5. The circulating air dryer of claim 1, characterized in that the holes (37) have different cross sections.

6. The circulating air dryer of claim 1, characterized in that the displacement device includes at least one Bowden cable (33) and one adjusting device (35).

7. The circulating air dryer of claim 1, characterized in that the displacement device includes at least one hydraulic or pneumatic cylinder.

8. The circulating air dryer of claim 1, characterized in that reinforcements (38) are disposed on each plate (30)

9. The circulating air dryer of claim 1, characterized in that the means for closure are disposed only on the lower nozzle chests (8).
